(19) United States
(12) Patent Application Publication
(10) Pub. No.: US 2003/0018703 A1
(43) Pub. Date: Jan. 23, 2003

(54) Smart appliance network system and communication protocol

(76) Inventors: Christian Huitema, Clyde Hill, WA (US); David J. Marples, Notts (GB)

Correspondence Address: Joseph Giordano, Esq., Telcordia Technologies, Inc., 445 South Street Room 1G112R, Morristown, NJ, 07960, US

(21) Appl. No.: 09/775,000

(22) Filed: Jan. 31, 2001

(51) Int. Cl. G06F 15/16

(52) U.S. Cl. 709/202; 709/230

(57) ABSTRACT

A smart appliance network protocol implemented through modifications to the Session Initiation Protocol (SIP), which is used to network a plurality of smart appliances together. The SIP smart appliance network protocol includes a general global naming scheme and a one-step action-location process to communicate messages between network components which include smart appliances. The general global naming scheme enables smart appliances and other network components to address messages to each other in general terms, thereby creating a scalable network that is flexible, easily modified, and accessible from a global location outside local smart appliance networks. The one-step location-action process enables messages to locate the recipient network component as it traverses the network and to carry the action to be performed by the recipient network component, in the same message, thereby reducing the burden on the local network firewall to guarantee secure access of a local smart appliance network to global components.

### CROSS-REFERENCE TO RELATED APPLICATIONS

This application is related to commonly owned U.S. patent application Ser. No. ______ (Docket APP 1357) filed concurrently herewith and entitled “System and Method For Using Session Initiation Protocol (SIP) to Communicate with Networked Appliances” which is incorporated by reference herein.

### FIELD OF THE INVENTION

The present invention generally relates to network communication protocols. More specifically, this invention relates to communication protocols used in smart appliance networks.

### BACKGROUND OF THE INVENTION

With the advent of the digital age, many traditional products have been ushered into a new era via the integration of classical product functionality and modern digital technology. Among the many types of digitally enhanced products, one prominent category that has undergone this transformation is home and business appliances. The synthesis of traditional appliance designs and modern digital technology has yielded a new class of “intelligent” or “smart” appliances, which incorporate the purpose and functionality of traditional appliances, such as clocks, lamps, refrigerators, and thermostats, with the benefits of digital technology, such as data processing systems.

Smart appliances are able to perform ordinary tasks with extraordinary precision and efficiency by using digital information and algorithms to determine how to optimally perform their tasks. A simple example is a digital thermostat, which uses input data, configuration information, temperature sensors, and processing algorithms to automatically monitor and adjust a room's temperature. Although smart appliances such as the digital thermostat realize marginal performance improvements due to their self-contained digital technology, they can achieve additional performances by exploiting digital networks. By networking smart appliances, server systems, and other digital components as a smart appliance network, smart appliances are able to act collaboratively with other network components, thereby maximizing their performance capabilities.

Smart appliances that are part of a smart appliance network are able to exchange information, share resources, and coordinate their activities, all of which enable them to perform their tasks more precisely and efficiently. For example, a smart refrigerator that is part of a smart appliance network can monitor grocery use, and then automatically place grocery orders to a supermarket via a network connection. Similarly, a digital thermostat that is part of a smart appliance network can not only regulate room temperature by controlling a central air conditioner or heater, but can also regulate room temperature by controlling separate smart fans networked and distributed throughout a room, house, or building.

A smart appliance network includes a group of local and/or global network agents, including smart appliances, users, and computer systems, that are interconnected via a local and/or global network connection such as the Internet. Local network agents are connected as a local smart appliance network, which is shielded from unauthorized global access via a protection mechanism such as a network firewall. Global network agents are external to the local smart appliance network and connected to other global and/or local network agents. Authorized global network agents may access local network agents to communicate commands and information from a location external to the local smart appliance network.

Both local and global network agents communicate across the network via network messages. Local network agents communicate within the local smart appliance network via local messages that are communicated without control or monitoring from the local network firewall. In contrast, local network agents communicate with global network agents, and vice versa, via global messages which are controlled and monitored by local network firewalls, thereby ensuring secure global access to the local smart appliance network by global network agents.

Network messages include commands, requests, and/or data that a requesting agent originates and sends to an object agent. Network messages are transmitted from a requesting agent to an object agent either directly, or via intermediate agents which route the message across the network. When a receiving agent receives the message, the receiving agent executes the message payload, which includes the commands, requests, and/or data sent by the requesting agent. Thus, network agents such as smart appliances are able to exchange messages with other network agents including other smart appliances, users, and computer systems in order to share information and coordinate activities. In addition, smart appliances and other network agents may both send and receive messages, thereby acting as both requesting and object agents, respectively.

In order to realize the benefits of a smart appliance network, the communication protocol used by smart appliances to exchange messages becomes a critical factor. When designing a smart appliance network communication protocol, a number of essential features for such a protocol are immediately apparent.

The first essential feature of a smart appliance network communication protocol is scalability, meaning that expansion of the network structure and communication between network agents is easily achieved. A scalable smart appliance network system requires a general addressing scheme independent of physical infrastructure. Otherwise, smart appliance address information will have to be updated every time a network component address changes, creating an inflexible, static network. Thus, in order to achieve scalability, the smart appliance network communication protocol addressing scheme must use general network addresses to communicate messages between network agents.

Although network agents must use a general addressing scheme to achieve scalability, network agents must still be able to determine the actual physical address of a network agent in order to deliver a message. Thus, network agents and messages must use a general addressing scheme, such as “turn on bedroom lamp,” rather than an actual addressing scheme, such as “send a message to controller at IP address 1.23.45.67 port 1234, and turn on item 123,” in order to achieve scalability, but network agents must also be able to determine that the general address “bedroom lamp” corresponds to an actual address “the controller at IP address 1.23.45.67 port 1234.”

The classic solution for these general address and actual address requirements is a lookup directory system, wherein network agents address other network agents using general names, such as the network agent name. These general names are then translated into an actual network address using an address translation table, and the actual address is used to communicate the message across the smart appliance network. Communication protocols such as Service Location Protocol (SLP) perform this precise function, but are nonetheless insufficient because they assume the network is local in scope. Thus, a local smart appliance network that uses SLP or a similar protocol cannot communicate with global network agents, and the smart appliance network is artificially limited to a local scope. The smart appliance communication protocol must therefore use a general global naming scheme to facilitate scalability and enable global smart appliance network access.

The second essential feature of the smart appliance network communication protocol is that the local smart appliance network is secure yet accessible by authorized global network agents. Global network agents must be able to access local network agents, and yet the local smart appliance network must remain secure from unauthorized global access. For example, smart appliances located in a user's home may be organized as a local network domain, whose general domain address is the user's home address The user may want to access a smart appliance within this local network domain, such as a thermostat, from a global location, such as the user's work, in order to communicate a message, such as when the user is leaving work. The thermostat then uses this and other information to regulate the house temperature prior to the user's arrival. Thus, the user must be able to globally access the local smart appliance network, and yet the local smart appliance network must act to ensure the user is authorized to access the local smart appliance network.

Traditional communication protocols implement a two-step location-action process to guarantee local network accessibility and security. Applying these traditional protocols to the smart appliance network structure, the first step is the location step, wherein the requesting agent determines the location of the object agent it seeks to access. In the location step, the object agent location is determined by first determining the local network domain of the object agent, and then determining the object agent location within the local network domain. Thus, for the example above, the local domain of the thermostat is first determined to be the user's home address, and then the thermostat is located within the home domain.

This location step is relatively complex, because the local domain, and the network agent location within the local domain, must be determined. This step is even more complex because the object agent location process is performed by a chain of multiple intermediate network agents, wherein each intermediate network agent uses the object agent address to determine the next recipient network agent. This step is further complicated by the fact that the network firewall must ensure secure local smart appliance network access in this location step, and in the subsequent action step and thus there is the possibility for incursion.

In order to guarantee secure local smart appliance network access in the location step, the network firewall identifies and validates the requesting agent and determines that the requesting agent is authorized to access the local smart appliance network. This is a relatively simple task and does not require much oversight by the network firewall.

In order to guarantee secure local smart appliance network access in the subsequent action step, however, the local network firewall must issue a security token or similar device to the requesting agent in the location step. The requesting agent then uses this security token in the action step to identify itself to the local network firewall as an authorized requesting agent, thereby creating a gateway for the requesting agent to communicate with the local smart appliance network. Thus, the local network firewall must monitor the security tokens sent by multiple requesting agents in the subsequent action step, which imposes a significant burden on the local network firewall. This burden introduces uncertainty and inefficiency for maintaining secure global access of the local smart appliance network which is directly attributable to the two-step location-action process, which potentially opens up opportunities for exploitation.

In sum, current smart appliance network communication protocols face a number of obstacles, of which three are most significant. First, the scalability requirement demands a general global naming scheme in order to provide a flexible, dynamic smart appliance network design. Second, the traditional two-step location-action process imposes significant burdens on the firewall to the local network, and hence introduces uncertainty and inefficiency when attempting to guarantee secure global access of the local smart appliance network. Third, the variety of different network architectures, with independent addressing schemes, used in the local domain precludes uniform access from the wide area.

### SUMMARY OF THE INVENTION

These and other deficiencies in smart appliance network communication protocols are addressed by the present invention, which is a method and apparatus for a smart appliance network communication protocol that includes a general global naming scheme and a one-step location-action process. The general global naming scheme meets the scalability requirement by using general network agent names to address messages within the network, thereby allowing a flexible network structure and ease of communication between network components. The one-step location-action process meets the secure global access of the local smart appliance network requirement by consolidating the location and action steps into a single step, thereby eliminating the inefficiency and uncertainty associated with issuing and monitoring security tokens to global network agents.

The general global naming scheme included in the smart appliance communication protocol enables a requesting agent to address an object agent using the object agent's general name rather than actual network address. Thus, the smart appliance network is scalable, because network agents can be added, removed, and relocated within the local smart appliance network without modifying the address used by requesting agents to locate and communicate with object agents. The general global naming scheme also enables global network agents to communicate with local network agents by specifying the local domain of the local network agent and the location of the local network agent within the local domain. Thus, the general global naming scheme maintains scalability while enabling smart appliance networks to have a global and/or local scope.

The general global naming scheme method includes a number of steps. First, a local smart appliance network is established, wherein local network agents are connected and each is assigned or obtained a general, unique local network address. Second, the local smart appliance network is connected to a global network, such as the Internet, wherein the local smart appliance network is assigned a general, unique local network domain address. Third, a global requesting agent addresses a message to a local object agent by specifying its global object agent name, which includes the general local network domain of the object agent and the general local network address of the object agent. Fourth, the global requesting agent sends the message, which is routed to the local object agent by determining the actual local network domain address and actual local network address that corresponds to the object agent's general local network domain address and the general local network address, respectfully. Fifth, the object agent receives the requesting agent message.

The second function included in the smart appliance communication protocol is a one-step location-action process, wherein a single location-action message includes the address of the object agent and the action to be performed by the object agent. Thus, whereas the two-step location-action process requires the requesting agent to first gain global access to an object agent, and then send actions to the object agent, the one-step location-action process includes both the initial object agent location and action processes in a single message, thereby eliminating the need for the local network firewall to issue, maintain, and monitor security tokens from numerous requesting agents.

The one-step location-action process method includes a number of component actions. First a global requesting agent originates a message, which includes the message address, and the message payload. The message address is the general global name of the object agent, and the message payload is the action to be performed by the object agent upon receipt Second, the message is routed through the network to the local network firewall, which identifies the requesting agent, and determines whether or not the requesting agent is authorized to access the local smart appliance network. Third, if the requesting agent is authorized to access the local smart appliance network, the message is further routed to the object agent within the local smart appliance network. Fourth, the object agent receives the message and unpacks the payload, thereby retrieving the action sent by the requesting agent. Fifth, the object agent executes the action sent by the requesting agent by executing the command sent by the requesting agent, using data sent by the requesting agent, and/or responding to the request sent by the requesting agent.

The apparatus to implement the general global naming scheme and one-step location-communication methods for the smart appliance network communication protocol uses a modified version of the Session Initiation Protocol (SIP), which is tailored for use as a smart appliance network communication protocol. SIP uses a plurality of processes to establish a client-server session and facilitate endpoint-to-endpoint communication between network components. In particular, the known SIP INVITE process satisfies most of the necessary requirements for the smart appliance network communication protocol, because it includes a general global naming scheme and can be realized to include a one-step location-action process.

In regard to the general global naming scheme requirement, SIP performs general message routing across network elements in order to establish a session between two network endpoints. In addition, SIP messages are routed through a network using a high level addressing, wherein the message address is resolved and rewritten as the message progresses through the system, thereby making the addressing scheme global rather than local. The shortcoming of the SIP addressing mechanism is that the message addresses are actual addresses, rather than general addresses, such that SIP by itself cannot be used as a smart appliance network communication protocol. This is so because using SIP as is would require network agents to know the actual address of other network agents, which would impair the smart appliance network scalability.

In regard to the one-step location-action process, the SIP INVITE process uses a one-step location-action process, wherein the INVITE message includes both a message location and message payload. The message location includes the location of the object agent in the network, which is used by the network to route the message from the requesting agent to the object agent. The message payload includes the action to be performed by the object agent upon receipt, thereby eliminating the need for a local network firewall to issue and monitor security tokens to provide secure access in a subsequent action step. Thus, the SIP INVITE process comprises a one-step location-action process, because the action to be performed by the receiving agent is included with the original location message.

The shortcoming of the SIP INVITE process is that the message payload is limited to Session Description Protocol (SDP) packets, which arc tailored for actions solely related to establishing client-server sessions. Thus, the SIP INVITE process does not include appropriate action mechanisms that can be included as a payload to satisfy the communication requirements of a smart appliance network.

These issues with SIP and the SIP INVITE process are addressed by the present invention, which utilizes a modified SIP apparatus as the smart appliance network communication protocol. This modified SIP apparatus is referred to as the “SIP smart appliance communication protocol,” which incorporates the general features of the SIP and the SIP INVITE process, but modified in accordance with this invention.

First, instead of using an actual address as the message address as in the generic SIP, the SIP smart appliance communication protocol substitutes use of a general address format for the message address. An example of a suitable general address format substitute is based upon Lightweight Directory Address Protocol (LDAP). LDAP uses general addresses for a message address, thereby satisfying the scalability requirement for local smart appliance networks. For example, a message addressed to general local network address “my lamp” at the local smart appliance domain “my home” would be addressed as follows: “Idap://my_home.net/my_lamp.”

Second, instead of fixing the payload structure to include only the SDP commands carried in the SIP INVITE process, the SIP smart appliance network protocol expands the payload to include a general spectrum of network agent actions that are not limited to session-initiation actions. Thus, the SIP smart appliance network protocol includes a one-step location-action process, but broadens the available payload to include necessary smart appliance network actions, thereby eliminating the need for the local network firewall to issue and monitor security tokens. In particular, message payloads for the SIP smart appliance network protocol include MIME types defined using action languages for certain classes of smart appliances. The SIP smart appliance network protocol thereby fulfills the access and security requirements for the smart appliance network communication protocol.

### BRIEF DESCRIPTION OF THE DRAWINGS

The foregoing and other features of the present invention will be more readily apparent from the following detailed description and drawings of illustrative embodiments of the invention in which:

FIG. 1 is a diagram of a Smart Appliance Network Architecture according to the present invention;

FIG. 2 is a flow diagram of a General Message Communication Process; and

FIG. 3 is a flow diagram of a General Global Address Translation Process.

### DETAILED DESCRIPTION OF THE PREFERRED EMBODIMENTS

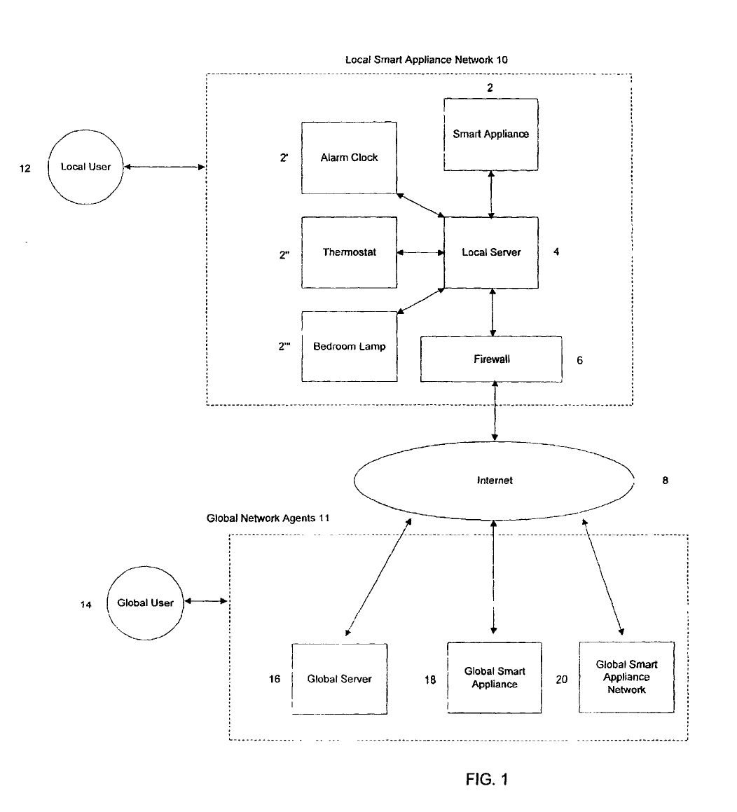

Referring now to FIG. 1, therein is shown a Smart Appliance Network Architecture illustrative of one specific embodiment of the present invention. The Smart Appliance Network Architecture includes a plurality of smart appliances 2, such as an alarm clock 2′, lamp 2″, and heating system 2′″, that are connected as a local smart appliance network 10, via their connection to a local server 4. The local server 4 is connected to other global network agents 11 via a network connection such as the Internet 8, and protected via a local network firewall 6, which monitors messages communicated by global network agents 11. It should be understood that the network architecture of the local smart appliance network 10 is not limited to the star configuration as shown, but may include all network configurations such that network agents are connected to one another either directly or via other network agents in a local fashion. It should also be understood that although the local server system 4 and network firewall 6 are shown as separate elements, these elements may be implemented together within a single server system that includes both server and firewall functions, or as a plurality of server systems that perform networking and firewall functions.

Global network agents 11 access the local smart appliance network 10 via a network connection such as the Internet 8. Global network agents 11 include global server systems 16, which include remote computer systems external to the local smart appliance network 10, and global smart appliances 18, which are smart appliances external to the local smart appliance network 10 Global network agents 11 also include other global smart appliance networks 20, which are smart appliance networks that are external to the local smart appliance network 10. It should be understood that the terms local and global are relative, such that a local smart appliance network 10 is a network of network agents organized in a local network configuration, wherein the network agents communicate messages that are not monitored by the local network firewall 6. In contrast, global smart appliance networks 20 may include network agents that are local unto themselves, but global to another local smart appliance network 10.

Local users 12 are able to access the local smart appliance network 10 and communicate messages with local network agents. Similarly, global users 14 are able to access and communicate with global network agents 11. Furthermore, via a network connection such as the Internet 8, local users 12 can also access and communicate with global network agents 11, and global users 14 can access and communicate with local network agents within the local smart appliance network 10.

The Smart Appliance Network Architecture shown in FIG. 1 demonstrates the necessity of a smart appliance network communication protocol that includes a general global naming scheme. For example, assume that the domain of the local smart appliance network 10 is “my home.” Under a general global naming scheme, a global server 16 is able to communicate information to the local smart appliance alarm clock 2′ by addressing a message to “my home alarm clock.” Without a general addressing scheme, the global server system would have to address the message to the actual network address of the alarm clock 2′, which would be difficult if the actual network address of the alarm clock 2′ changes. Similarly, the general global naming scheme is required to distinguish the alarm clock 2′ in the domain “my home” from alarm clocks in other domains such as “my work.”

Similarly, the Smart Appliance Network Architecture shown in FIG. 1 demonstrates the need for a single-step location-action process for global domain access. Using a one-step location-action process, global network agents 11 can locate a local network agent and include actions to be performed by the local network agent, in the same step. Thus, the local network firewall 6 only has to verify the global network agent's identity before allowing the global network agent 11 to communicate with the local smart appliance network 10. In contrast, a two-step location-action process would require the local network firewall 6 to issue a security token to the global network agent 11, and then monitor subsequent messages from the global agent 11 in the action step to ensure secure local smart appliance network access.

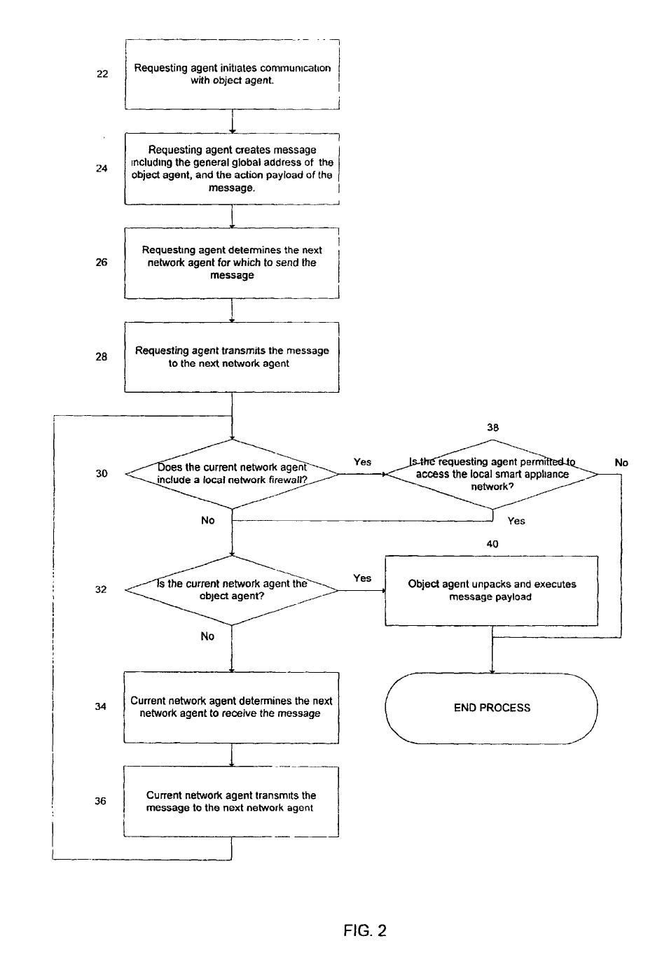

FIG. 2 shows a flow diagram of the General Message Communication Process in accordance with this invention. This is the process wherein a message is communicated from a requesting agent to an object agent using a smart appliance network protocol that includes both the general global naming scheme and the one-step location-action process. Thus, the General Message Communication Process satisfies the requirements of the general smart appliance network protocol.

Referring now to FIG. 2, the process begins when a global requesting agent initiates a communication with a local object agent (step 22). The requesting agent creates a message that includes the general global address of the object agent and the action payload to be performed by the object agent (step 24). The requesting agent determines the next network agent to which to send the message (step 26) and then transmits the message to the next network agent, which becomes the current network agent with the message (step 28).

The global requesting agent or server addresses the message to the local smart appliance network by specifying the general local network address of the local smart appliance network and, advantageously, the message may include the general local network domain of the appliance network. The global requesting agent sends the message, over the communication network, and the message is routed to the particular local smart network by determining, if needed, the actual local smart network domain address and the actual local smart network address that correspond to the local network's general local network domain address and the general local network address, respectively.

The global requesting agent or server addresses the message to the local smart appliance network by specifying the general local network address of the local smart appliance network and, advantageously, the message includes the general local network domain of the appliance network. The global requesting agent sends the message, over the communication network, and the message is routed to the particular local smart network using the actual local smart network domain address.

At step 30, it is determined if the current network agent includes a local network firewall. If not, the process proceeds to step 32. If so, the process proceeds to step 38, wherein the local network firewall determines whether or not the requesting agent is authorized to access the local smart appliance network. If so, the process proceeds to step 32, because the requesting agent is authorized to access the local smart appliance network. If not, the process ends, because the requesting agent does not have permission to access the local smart appliance network.

At step 32, it is determined if the current network agent is the object agent specified in the message address. If so, the process proceeds to step 40, wherein the object agent unpacks and executes the object payload, thereby performing the action and/or using the data sent by the requesting agent. If not, the process proceeds to step 34, because the current network agent is not the object agent, so the current network agent must be an intermediate network agent.

At step 34, the current intermediate network agent determines the next network agent that is to receive the message. The current intermediate network agent then transmits the message to the next network agent (step 38). This process continues until either the message arrives at and is executed by the object agent (step 40), or a local network firewall determines the requesting agent is not allowed to access the local smart appliance network (step 38).

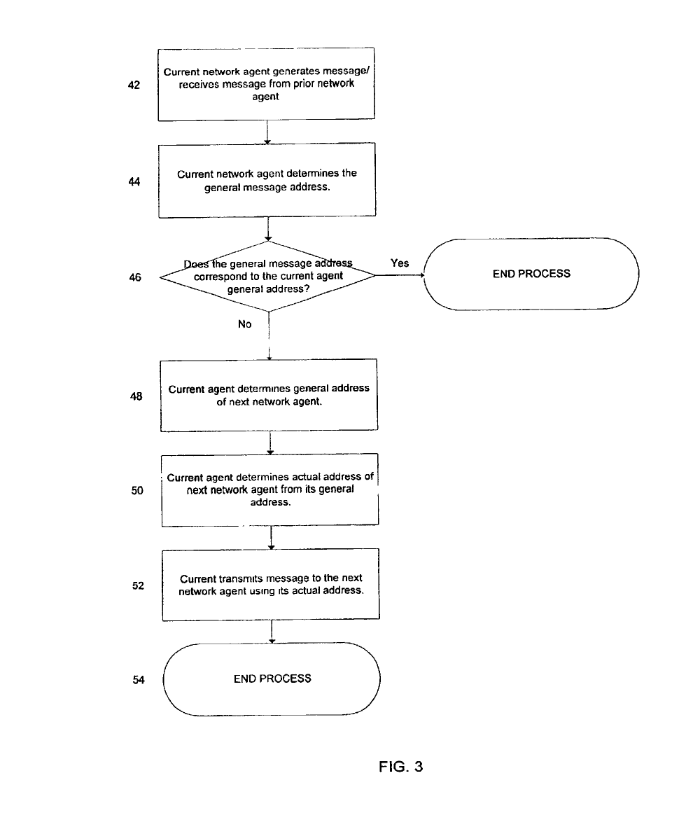

FIG. 3 is a flow diagram of the General Global Address Translation Process in accordance with this invention, wherein a single network agent transmits a message to the next network agent using its general address. A plurality of network agents repeat this process in order to transmit a message from the requesting agent to the object agent across the smart appliance network.

Referring to FIG. 3, the current network agent either generates the message, or receives the message from a prior network agent, based on whether the current network agent is the requesting agent, or an intermediate agent, respectively (step 42). The current network agent then determines the general message address by extracting the message address from the message (step 44).

At step 46, it is determined if the general message address corresponds to the general address of the current network agent. If so, the process ends, because the current network agent is the object agent of the message. Otherwise, the process proceeds to step 48.

At step 48, the current network agent processes the general message address to determine the general address of the next network agent that should receive the message. The current network agent then determines the actual address of the next network agent from its general address by using means such as an address translation table (step 50). The current network agent then transmits the message to the next network agent using its actual address (step 52).

While the invention has been particularly shown and described with reference to preferred embodiments thereof, it will be understood by those skilled in the art that various changes in form and details may be made therein without departing from the spirit and scope of the invention.

We claim:

1. A global appliance network system, comprising:
a local smart appliance network, including at least one smart appliance, said local smart appliance network having a general unique global network address;
a global network agent, including a global server, said global server communicating with said smart appliance using a general addressing scheme identifying in a single message both said smart appliance network by said general unique global network address and the instruction to be performed on said smart appliance; and
a communication network interconnecting said local smart appliance network and said global network agent.

2. The global appliance network system of claim 1, wherein said local smart appliance network includes a plurality of smart appliances.

3. The global appliance network system of claim 2, wherein said communication network is the Internet.

4. The global appliance network system of claim 1, wherein said global network agent also includes at least one smart appliance.

5. The global appliance network system of claim 1, wherein said global network agent also includes a global smart appliance network.

6. The global appliance network system of claim 1, wherein said general addressing scheme is a modified version of the Session Initiation Protocol.

7. The global appliance network system of claim 6, wherein the general address format of said general addressing scheme is Lightweight Directory Access Protocol.

8. A one-step location-action method for remotely operating a smart appliance in a local smart appliance network from a global agent in a global network, said method comprising the steps of:
the global agent formulating a one-step message that includes the general global address of the local smart appliance network and the action to be taken by the smart appliance;
transmitting the one-step message over a communication network to the local smart appliance network;
if between the global network and the local smart appliance network there is a fire wall, determining that the global agent is permitted to traverse the firewall; and
unpacking the transmitted one-step message and executing the action to be taken by the smart appliance.

9. The one-step location-action method of claim 8, wherein said step of transmitting the one-step message to the local smart appliance network comprises transmitting said one-step message through an intervening network.

10. The one-step location-action method of claim 8, wherein said one-step message utilizes a modified version of the Session Initiation Protocol.

11. The one-step location-action method of claim 10, wherein said modified version of the Session Initiation Protocol utilizes a Lightweight Directory Access Protocol.
